(19) United States
(12) Patent Application Publication
(10) Pub. No.: US 2018/0290608 A1
(43) Pub. Date: Oct. 11, 2018

(54) IN-VEHICLE POWER SUPPLY DEVICE

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP)

(72) Inventor: Yoshihiro Hida, Yokkaichi, Mie (JP)

(21) Appl. No.: 15/762,214

(22) PCT Filed: Sep. 12, 2016
(86) PCT No.: PCT/JP2016/076752

§ 371 Date: Mar. 22, 2018

(30) Foreign Application Priority Data
Sep. 24, 2015 (JP) 2015-186486

(51) Int. Cl. B60R 16/033; B60R 16/04; H02J 7/14; H02J 7/00

(52) U.S. Cl. CPC B60R 16/033; H02J 7/0054; H02J 7/14; B60R 16/04

(57) ABSTRACT

Provided is an in-vehicle power supply device that is less susceptible to the occurrence of sneak current between a main battery and a sub-battery that supply power externally. The in-vehicle power supply device includes a main battery for in-vehicle use and a sub-battery for in-vehicle use. The in-vehicle power supply device is further provided with a plurality of diode pairs and a switch connected in parallel to all of the diode pairs. The sub-battery is connected to the main battery via the switch. The two diodes of each diode pair are connected in series with forward directions opposite to each other.

### CROSS-REFERENCE TO RELATED APPLICATIONS

This application is the U.S. national stage of PCT/JP2016/076752 filed Sep. 12, 2016, which claims priority of Japanese Patent Application No. JP 2015-186486 filed Sep. 24, 2015.

### TECHNICAL FIELD

This disclosure relates to an in-vehicle power supply device.

### BACKGROUND

In recent years, advances have been made in the electrification of vehicle loads. There are also electrified loads that perform functions relating to travelling, steering and stopping. Therefore, loss of the battery function (including malfunction thereof, this similarly applies below) should be avoided. In view of this, a technology for mounting a sub-battery as a backup supply device has been proposed (refer to JP 2015-83404A below).

In JP 2015-83404A, power is supplied to a load (hereinafter, “backup load”) that is for backing up from a main battery and a sub-battery.

In JP 2015-83404A, as long as the main battery has not deteriorated and the charging rate of the sub-battery is within a suitable range, the main battery and the sub-battery are connected in parallel to the backup load via a switch. This causes concern about the occurrence of sneak current between the main battery and the sub-battery.

In view of this, an object of the present invention is to provide an in-vehicle power supply device that is less susceptible to the occurrence of sneak current between a main battery and a sub-battery that supply power externally.

### SUMMARY

An in-vehicle power supply device includes at least one diode pair, a switch connected in parallel to all of the diode pairs, a main battery for in-vehicle use, and a sub-battery for in-vehicle use that is connected to the main battery via the switch. The diode pair has a first diode and a second diode that are connected in series with forward directions opposite to each other.

An in-vehicle power supply device that is less susceptible to the occurrence of sneak current between a main battery and a sub-battery that supply power externally is provided.

### BRIEF DESCRIPTION OF DRAWINGS

FIG. 1 is a diagram showing an in-vehicle power supply device according to a first embodiment.

FIG. 2 is a diagram showing an in-vehicle power supply device according to a second embodiment.

FIG. 3 is a diagram showing an in-vehicle power supply device according to a variation.

FIG. 4 is a circuit diagram showing a first comparative example.

FIG. 5 is a circuit diagram showing a second comparative example.

### DETAILED DESCRIPTION OF PREFERRED EMBODIMENTS

### Comparative Example

In order to clarify the advantages of embodiments that will be discussed later, firstly comparative examples will be described as technologies for comparison with the embodiments.

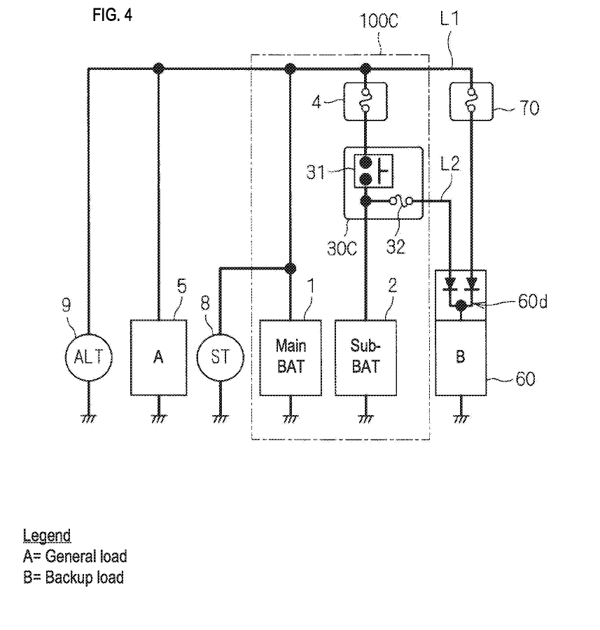

FIG. 4 is a circuit diagram showing a first comparative example. An in-vehicle power supply device 100C is provided with a main battery 1, a sub-battery 2, and a power supply box 30C.

The main battery 1 is for in-vehicle use and is charged from outside the in-vehicle power supply device 100C. Specifically, the main battery 1 is connected to an alternator 9 that is mounted in the vehicle, and is charged by a power generation function of the alternator 9.

A starter 8 together with a general load 5 is connected to the main battery 1, from outside the in-vehicle power supply device 100C. The general load 5 is a load that is not for backing up by the sub-battery 2, and is an in-vehicle air conditioner, for example. The starter 8 is a motor for starting an engine which is not shown. Because the general load 5 and the starter 8 are well-known loads and do not have characteristic features in the comparative examples or the embodiments, a detailed description thereof will be omitted.

A backup load 60 is a load to which power supply is desirably maintained even when power supply from the main battery 1 is lost, and a shift-by-wire actuator and an electronic brake force distribution system can be given as examples.

The sub-battery 2 is for in-vehicle use and is charged by at least one of the alternator 9 and the main battery 1. A lead storage battery, for example, is employed for the main battery 1, and a lithium ion battery, for example, is employed for the sub-battery 2. The main battery 1 and the sub-battery 2 are both concepts that include a capacitor, and an electric double-layer capacitor, for example, can also be employed for the sub-battery 2.

So that the charging current to the sub-battery 2 does not become over-current, the in-vehicle power supply device 100C is further provided with a fuse that interposes the power supply box 30C (specifically, a switch 31 discussed later) together with the sub-battery 2 and is connected in series to both thereof. The fuse is housed in a fuse box 4 in the illustrative example of FIG. 4.

The in-vehicle power supply device 100C supplies power to the backup load 60, via a main power supply path L1 and a sub-power supply path L2. The main power supply path L1 connects the main battery 1, the general load 5 and the backup load 60 in parallel, between the main power supply path and a fixed potential point (here, ground). That is, the general load 5 and the backup load 60 both receive power via the main power supply path L1.

The sub-power supply path L2 is connected to the power supply box 30C, and serves as a path for supplying power from the sub-battery 2 to the backup load 60. Accordingly, the backup load 60 is capable of receiving power not only from the main battery 1 via the main power supply path L1 but also from the sub-battery 2 via the sub-power supply path L2.

In order to prevent over-current in power supply to the backup load 60, a fuse is provided on both the main power supply path L1 and the sub-power supply path L2. FIG. 4 illustrates the case where the fuse on the main power supply path L1 is provided in a fuse box 70, and a fuse 32 on the sub-power supply path L2 is provided in the power supply box 30C.

The power supply box 30C houses the switch 31 and the abovementioned fuse 32. A relay, for example, can be employed for the switch 31. The sub-power supply path L2 is lead out from a connection point of the sub-battery 2 and the switch 31.

When charging the sub-battery 2, the switch 31 is in a closed state, and when not charging the sub-battery 2, the closed state/open state is selected according to the operation. In the comparative examples and the embodiments, such selection of the closed state/open state of the switch 31 when not charging the sub-battery 2 is not essential. Therefore, a detailed description of this selection will be omitted, suffice to pointing out that, here, the selection is performed by a control device which is not shown, such as an in-vehicle ECU (engine control unit), for example.

Incidentally, although not clear from JP 2015-83404A, it is desirable to avoid sneak current between the main battery 1 and the sub-battery 2 (hereinafter, provisionally “inter-battery circulating current”), in the case of supplying power to the backup load 60 with two power supply paths in this way. This is because inter-battery circulating current causes degradation of one or both of the main battery 1 and the sub-battery 2.

The occurrence of inter-battery circulating current can be avoided with a diode group 60d that is provided accompanying the backup load 60. Here, the case where both the main battery 1 and the sub-battery 2 apply a voltage to the positive electrode side of the backup load 60 is envisaged. Both cathodes of a pair of diodes constituting the diode group 60d are disposed facing the backup load 60, and anodes thereof are respectively disposed facing the main power supply path L1 and the sub-power supply path L2.

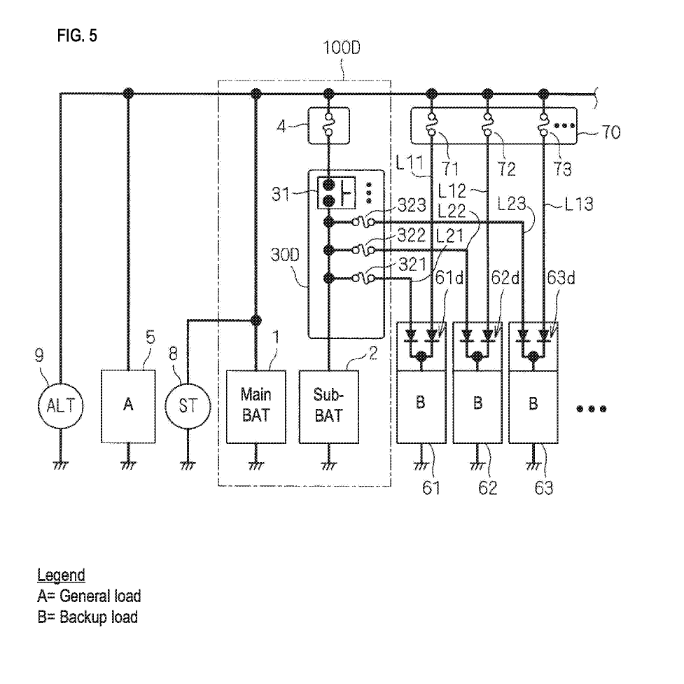

FIG. 5 is a circuit diagram showing a second comparative example. An in-vehicle power supply device 100D is provided with a main battery 1, a sub-battery 2 and a power supply box 30D. In the second comparative example, a plurality of backup loads 61, 62, 63 and so on are provided, different from the first comparative example.

In the second comparative example, a main power supply path L1 connects the main battery 1, a general load 5 and the backup loads 61, 62, 63 and so on in parallel between the main power supply path and ground, similarly to the first comparative example. The general load 5 receives power via a main power supply path L1, similarly to the first comparative example.

The main power supply path L1 branches into power supply branches L11, L12, L13 and so on, and the branches respectively serve as power supply paths to the backup loads 61, 62, 63 and so on. In order to prevent over-current in the backup loads 61, 62, 63 and so on, fuses 71, 72, 73 and so on respectively corresponding to the power supply branches L11, L12, L13 and so on are provided. FIG. 5 illustrates the case where the fuses 71, 72, 73 and so on are housed in a fuse box 70.

The in-vehicle power supply device 100D in the second comparative example has a configuration in which the power supply box 30C of the in-vehicle power supply device 100C in the first comparative example is replaced by the power supply box 30D. The power supply box 30D has the switch 31 described in the first comparative example. The switch 31 is interposed between the sub-battery 2 and the fuse that is in the fuse box 4, and is connected in series to both thereof.

In the second comparative example, a plurality of sub-power supply paths L21, L22, L23 and so on are provided instead of the sub-power supply path L2 shown in the first comparative example, and these sub-power supply paths are lead out from the power supply box 30D, or more specifically, from connection points of the sub-battery 2 and the switch 31. The sub-battery 2 respectively supplies power to the backup loads 61, 62, 63 and so on, via the sub-power supply paths L21, L22, L23 and so on. In order to prevent over-current in the backup loads 61, 62, 63 and so on, fuses 321, 322, 323 and so on respectively corresponding to the sub-power supply paths L21, L22, L23 and so on are provided. FIG. 5 illustrates the case where the fuses 321, 322, 323 and so on are housed in the power supply box 30D.

The backup load 61 is capable of receiving power not only from the main battery 1 via the power supply branch L11 but also from the sub-battery 2 via the sub-power supply path L21. Therefore, in order to avoid the occurrence of inter-battery circulating current in the backup load 61, a diode group 61d is provided. The diode group 61d is constituted by a pair of diodes, similarly to the diode group 60d shown in the first comparative example. Both cathodes of this pair of diodes are disposed facing the backup load 61, and anodes thereof are respectively disposed facing the power supply branch L11 and the sub-power supply path L21.

Diode groups 62d, 63d and so on are similarly provided for the other backup loads 62, 63 and so on. However, providing the diode groups 61d, 62d, 63d and so on for the backup loads 61, 62, 63 and so on in this way invites not only cost increases due to number of components but also cost increases due to the increase in design processes. This problem becomes more prominent with a large number of backup loads as in the second comparative example than in the first comparative example.

Cost increases due to the increase in design processes will be described in more detail. There is a history of designing in-vehicle power supply devices and loads with a design concept that does not employ a sub-battery 2, and diode groups have naturally not been envisaged with the design of these loads. Therefore, in the case of designing the in-vehicle power supply devices 100C and 100D with a design concept that uses the sub-battery 2, the design of the backup loads 60, 61, 62, 63 and so on, in addition to the power supply devices themselves, also needs to be newly carried out taking account of the diode groups.

However, as shown with the above object, as long as an in-vehicle power supply device that is less susceptible to the occurrence of sneak current between a main battery 1 and a sub-battery 2 that supply power externally is obtained, the actual design of the loads targeted for power supply need not be changed, and cost increases due to diode groups being individually provided can also be avoided.

Hereinafter, in-vehicle power supply devices according to a plurality of embodiments will be described. In all of the embodiments, unless particularly stated otherwise, constituent elements to which the same reference signs as the above comparative examples are given perform the same or equivalent functions as the constituent elements of the comparative examples.

### First Embodiment

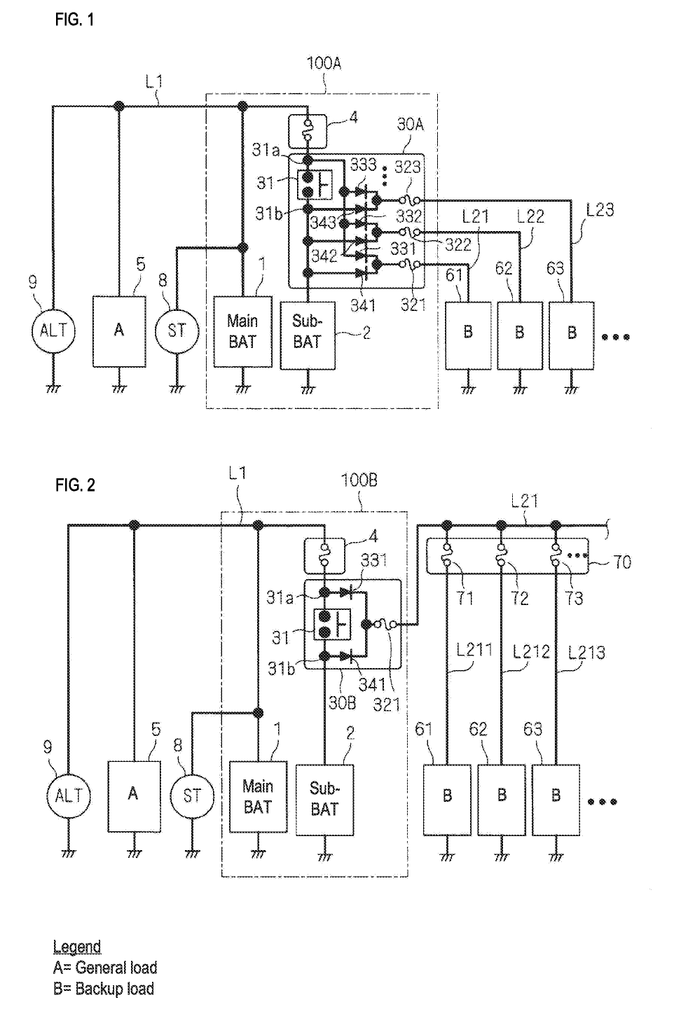

FIG. 1 is a circuit diagram showing the connection relationship of backup loads 61, 62, 63 and so on in addition to a general load 5 with an in-vehicle power supply device 100A that supplies power to these loads.

### Configuration

The in-vehicle power supply device 100A is provided with a main battery 1, a sub-battery 2 and a power supply box 30A. Similarly to the in-vehicle power supply devices 100C and 100D, the in-vehicle power supply device 100A is desirably further provided with a fuse that interposes a power supply box 3 together with the sub-battery 2 and is connected in series to both thereof. Here, the case where this fuse is housed in a fuse box 4, similarly to the first comparative example and the second comparative example, will be illustrated.

The main battery 1 is charged by the power generation function of an alternator 9, from outside the in-vehicle power supply device 100A. A starter 8 is connected together with the general load 5 to the main battery 1, from outside the in-vehicle power supply device 100A. The general load 5 receives power via the main power supply path L1, similarly to the first comparative example and the second comparative example.

The in-vehicle power supply device 100A in the present embodiment has a configuration in which the power supply box 30D of the in-vehicle power supply device 100D in the second comparative example is replaced by the power supply box 30A. The power supply box 30A has the switch 31 described in the first comparative example and the second comparative example. The switch 31 is interposed between the sub-battery 2 and the fuse that is in the fuse box 4, and is connected in series to both thereof. The sub-battery 2 is connected to the main battery 1 via the switch 31.

In the present embodiment, the sub-battery 2 respectively supplies power to the backup loads 61, 62, 63 and so on, via sub-power supply paths L21, L22, L23 and so on, similarly to the second comparative example. Also, fuses 321, 322, 323 and so on respectively corresponding to the sub-power supply paths L21, L22, L23 and so on are provided, similarly to the second comparative example. FIG. 1 illustrates the case where the fuses 321, 322, 323 and so on are housed in the power supply box 30A.

The power supply box 30A is provided with diodes 331 and 341 forming a diode pair. The diodes 331 and 341 are connected in series with forward directions opposite to each other. Here, the case where both the main battery 1 and the sub-battery 2 apply a voltage to the anode side of a backup load is envisaged, and, therefore, the cathodes of the diodes 331 and 341 are connected to each other. The sub-power supply path L21 is connected to the connection points of the diodes 331 and 341, which are here the cathodes thereof.

The power supply box 30A is also provided with diodes 332 and 342 forming a diode pair. These diodes are also connected in series with forward directions opposite to each other, and the connection points (here, respective cathodes) of both diodes are connected to the sub-power supply path L22. Diodes 333 and 343 are similarly connected in series with forward directions opposite to each other to form a diode pair, and the connection points of both diodes are connected to the sub-power supply path L23.

The switch 31 is connected in parallel to all of the above diode pairs. That is, the anodes of the diodes 331, 332 and 333 are connected to an end 31a on the fuse box 4 side of the switch 31, and the anodes of the diodes 341, 342 and 343 are connected to an end 31b on the sub-battery 2 side of the switch 31.

### Operations

In the case where the charging rate of the sub-battery 2 is low, the switch 31 becomes electrically connected and the sub-battery 2 is charged by at least one of the main battery 1 and the alternator 9. Even if current flows between the main battery 1 and the sub-battery 2 at this time, this current is charging current that flows toward the sub-battery 2 from the main battery 1, and does not adversely affect either battery. In the case where the charging rate of the sub-battery 2 reaches a suitable range, the switch 31 becomes electrically disconnected and charging of the sub-battery 2 is stopped.

In a state where the sub-battery 2 has been charged, the switch 31 is electrically disconnected. Because the diodes 331 and 341 are connected in series with forward directions opposite to each other at this time, the diode group does not interfere with a situation where the switch 31 is open. This similarly applies to the diodes 332 and 342 and the diodes 333 and 343.

Therefore, it is possible to supply power to outside the in-vehicle power supply device 100A (here, to backup loads 61, 62, 63, etc.) both from the main battery 1 and from the sub-battery 2, via the sub-power supply paths L21, L22, L23 and so on (or further via the fuses 321, 322, 323, etc.), and inter-battery circulating current is avoided.

Because the diodes 331, 332, 333, 341, 342 and 343 are provided in the in-vehicle power supply device 100A, diode groups 60d, 61d, 62d, 63d and so on such as in the first comparative example and the second comparative example need not be provided for the backup loads 60, 61, 62, 63 and so on, and thus new design processes for the respective diode groups are not required.

Moreover, even in the case where both the alternator 9 and the main battery 1 lose the power supply function (including failure thereof), power supply to outside (here, to backup loads 61, 62, 63, etc.) can be secured from the sub-battery 2 via the cathodes of the diodes 341, 342, 343 and so on.

The present embodiment is, furthermore, advantageous in that power supply is simplified because power supply branches L11, L12, L13 and so on such as in the second comparative example are not required, and the number of components is cut due to the fuses 71, 72, 73 and so on also not being required. Specifically, the number of fuses is reduced by the number of backup loads, as compared with the second comparative example.

### Second Embodiment

FIG. 2 is a circuit diagram showing the connection relationship of backup loads 61, 62, 63 and so on in addition to a general load 5 with an in-vehicle power supply device 100B that supplies power to these loads.

### Configuration

The in-vehicle power supply device 100B has a configuration in which the power supply box 30A of the in-vehicle power supply devices 100A described in the first embodiment is replaced by a power supply box 30B. The power supply box 30B has a configuration in which the diodes 332, 333 and so on, the diodes 342, 343 and so on, and the fuses 322, 323 and so on are eliminated from the power supply box 30A. More specifically, diodes 331 and 341 forming a diode pair are connected in series, and the cathodes thereof are connected to a sub-power supply path L21. A switch 31 is connected in parallel to this diode pair. Although there is one diode pair here, it is possible for the switch 31 to be connected in parallel to all diode pairs, similarly to the first embodiment.

The sub-power supply path L21 branches into power supply branches L211, L212, L213 and so on, on the opposite side to the diodes 331 and 341 with respect to a fuse 321, and the branches respectively serve as power supply paths to the backup loads 61, 62, 63 and so on. In order to prevent over-current in the backup loads 61, 62, 63 and so on, fuses 71, 72, 73 and so on respectively corresponding to the power supply branches L211, L212, L213 and so on are provided. FIG. 2 illustrates the case where the fuses 71, 72, 73 and so on are housed in a fuse box 70.

In the present embodiment, the functions of the diodes 331, 332, 333 and so on, the diodes 341, 342, 343 and so on, and the fuses 321, 322, 323 and so on in the first embodiment are respectively provided by the diode 331, the diode 341 and the fuse 321.

### Operations

The connection point where the diode 331 and the diode 341 are connected in one diode pair is thus connected to one end of each of the plurality of backup loads 61, 62, 63 and so on. Therefore, it is possible to supply power to outside the in-vehicle power supply device 100B (here, to backup loads 61, 62, 63, etc.) both from the main battery 1 and from the sub-battery 2, via the sub-power supply path L2 and the power supply branches L211, L212, L213 and so on (or further via the fuse 321, 71, 72, 73, etc.), and inter-battery circulating current is avoided.

Similarly to the first embodiment, diode groups 60d, 61d, 62d, 63d and so on need not be provided for the backup loads 60, 61, 62, 63 and so on, and thus new design processes for the respective diode groups are not required.

Moreover, even in the case where both the alternator 9 and the main battery 1 lose the power supply function, power supply to outside (here, to backup loads 61, 62, 63, etc.) from the sub-battery 2 can be secured.

In the present embodiment, furthermore, the number of diodes is reduced by twice a value obtained by subtracting 1 from the number of backup loads, as compared with the first embodiment. That is, the present embodiment is more advantageous than the first embodiment from the viewpoint that a large number of diodes need not be provided even if there are a large number of backup loads, and the number of components is reduced.

Also, because the functions of the fuses 321, 322 and 323 in the first embodiment are substantially provided for by the functions of the fuses 71, 72, 73 and so on, the fuse 321 can also be omitted in the present embodiment, with the number of components being further reduced in this case.

On the other hand, in the first embodiment, a diode pair is provided for every backup load, enabling the specification of the diodes forming each diode pair to be appropriately selected. Therefore, the first embodiment is advantageous from the viewpoint that the diodes are less susceptible to being excessively specced (over-engineered), as compared with the second embodiment.

Although the in-vehicle power supply device has been described in detail above, the foregoing description is, in all respects, illustrative, and the invention is not limited thereto. It should be understood that innumerable variations that are not illustrated can be conceived without departing from the scope of the appended claims.

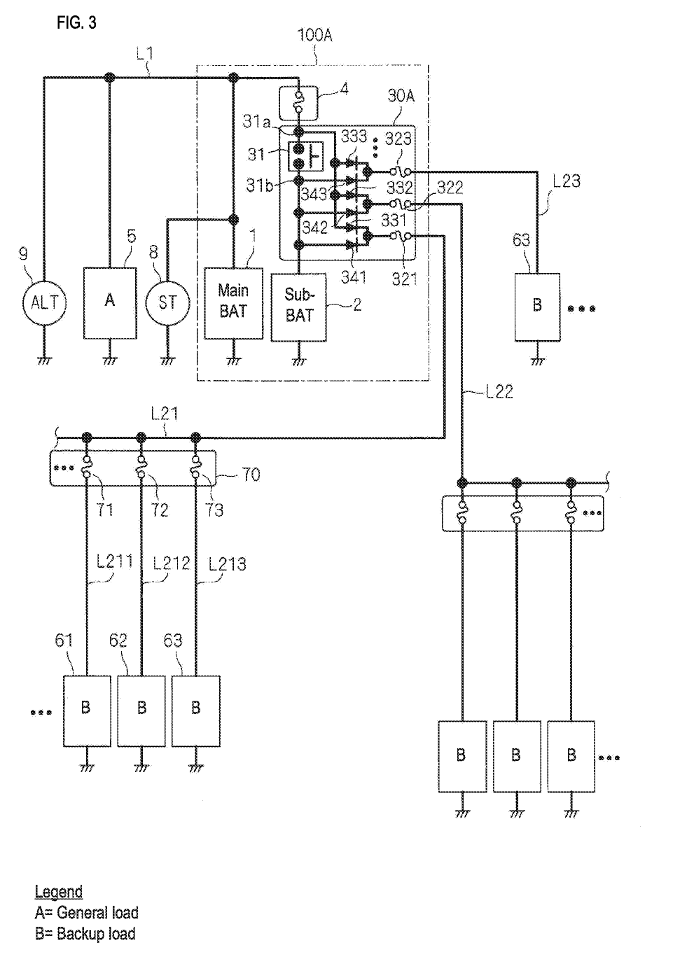

For example, the sub-power supply path L21 of the second embodiment may be applied to the sub-power supply path L21 of the first embodiment, and branched into the power supply branches L211, L212 and L213, and these branches may serve as power supply paths to a plurality of backup loads. Furthermore, the sub-power supply path L22 of the first embodiment may, similarly to the sub-power supply path L21 of the second embodiment, be branched into a plurality of power supply branches, and serves as power supply paths to a plurality of backup loads (refer to FIG. 3).

### FIGURES

### [FIG. 1] [FIG. 2] [FIG. 5]

1 MAIN BAT
2 SUB-BAT
5 GENERAL LOAD
61, 62, 63 BACKUP LOAD

### [FIG. 3]

1 MAIN BAT
2 SUB-BAT
5 GENERAL LOAD
61, 62, 63 BACKUP LOAD [symbol]
   BACKUP LOAD

### [FIG. 4]

1 MAIN BAT
2 SUB-BAT
5 GENERAL LOAD
60 BACKUP LOAD

1. An in-vehicle power supply device comprising:
at least one diode pair that has a first diode and a second diode that are connected in series with forward directions opposite to each other;
a switch connected in parallel to all of the diode pairs;
a main battery for in-vehicle use; and
a sub-battery for in-vehicle use that is connected to the main battery via the switch.

2. The in-vehicle power supply device according to claim 1,
wherein the diode pair is provided for every load targeted for power supply from the sub-battery.

3. The in-vehicle power supply device according to claim 1,
wherein a connection point where the first diode and the second diode are connected in one of the diode pairs is connected to one or a plurality of loads targeted for power supply from the sub-battery.
